(19) United States
(12) Patent Application Publication
(10) Pub. No.: US 2025/0071001 A1
(43) Pub. Date: Feb. 27, 2025

(54) TRIGGERING A FREQUENCY-DEPENDENT SUBBAND IMPAIRMENT ESTIMATE AT A USER EQUIPMENT (UE)

(71) Applicant: QUALCOMM Incorporated, San Diego, CA (US)

(72) Inventors: Aviv REGEV, Tel Aviv (IL); Ronen SHAKED, Kfar Saba (IL); Amit MOSES, Tel Aviv (IL)

(21) Appl. No.: 18/456,448

(22) Filed: Aug. 25, 2023

(51) Int. Cl. H04L 25/02; H04W 24/08

(52) U.S. Cl. CPC H04L 25/0202; H04W 24/08

(57) ABSTRACT

A method for wireless communication at a user equipment (UE) includes receiving, from a network node, a second message including a command to update a current frequency-dependent subband impairment estimate or a command to maintain the current frequency-dependent subband impairment estimate. The method further includes canceling the frequency-dependent subband impairment in accordance with receiving the second message. The cancelling may be in accordance with: the current frequency-dependent subband impairment estimate in accordance with the second message including the command to maintain the current frequency-dependent subband impairment estimate, or an update to the current frequency-dependent subband impairment estimate in accordance with the second message including the command to update the current frequency-dependent subband impairment estimate.

### FIELD OF THE DISCLOSURE

The present disclosure relates generally to wireless communication, and more specifically to a network node triggering a frequency-dependent subband impairment estimate at a user equipment (UE).

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (for example, bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IoT) and enhanced machine-type communications (eMTC) are a set of enhancements to LTE for machine type communications.

A wireless communications network may include a number of base stations (BSs) that can support communications for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail, a BS may be referred to as a Node B, an evolved Node B (eNB), a gNB, an access point (AP), a radio head, a transmit and receive point (TRP), a new radio (NR) BS, a 5G Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (for example, also known as discrete Fourier transform spread OFDM (DFT-s-OFDM)) on the uplink (UL), as well as supporting beamforming, multiple-input multiple-output (MIMO) antenna technology, and carrier aggregation.

A mismatch between in-phase (I) and quadrature (Q) components of a signal may result in a frequency-dependent subband impairment, such as a frequency-dependent residual side band (FDRSB). The frequency-dependent subband impairment may interfere with wireless communication, and the interference may increase as a carrier frequency increases. Additionally, the frequency-dependent subband impairment may increase as a number of transmission antennas increases at a network node. In some cases, the network node may attempt to maintain the impairment level of the frequency-dependent subband impairment below an impairment threshold to enable the transmission of low-order quadrature amplitude modulation (QAM) symbols. Additionally, or alternatively, a receiver, such as a user equipment (UE), may attempt to estimate and cancel or reduce the frequency-dependent subband impairment.

### SUMMARY

In some aspects of the present disclosure, a method for wireless communication by a user equipment (UE) includes receiving, from a network node, a first message including a command to update a current frequency-dependent subband impairment estimate or a command to maintain the current frequency-dependent subband impairment estimate. The method still further includes canceling a frequency-dependent subband impairment in accordance with receiving the first message. The cancelling may be in accordance with the current frequency-dependent subband impairment estimate in accordance with the first message including the command to maintain the current frequency-dependent subband impairment estimate, or an update to the current frequency-dependent subband impairment estimate in accordance with the first message including the command to update the current frequency-dependent subband impairment estimate.

Some other aspects of the present disclosure are directed to an apparatus including means for receiving, from a network node, a first message including a command to update a current frequency-dependent subband impairment estimate or a command to maintain the current frequency-dependent subband impairment estimate. The apparatus further includes means for canceling a frequency-dependent subband impairment in accordance with receiving the first message. The cancelling may be in accordance with the current frequency-dependent subband impairment estimate in accordance with the first message including the command to maintain the current frequency-dependent subband impairment estimate, or an update to the current frequency-dependent subband impairment estimate in accordance with the first message including the command to update the current frequency-dependent subband impairment estimate.

In some other aspects of the present disclosure, a non-transitory computer-readable medium with non-transitory program code recorded thereon is disclosed. The program code is executed by one or more processors and includes program code to receive, from a network node, a first message including a command to update a current frequency-dependent subband impairment in accordance with receiving the first message. The program code also includes program code to cancel a frequency-dependent subband impairment in accordance with receiving the first message. The cancelling may be in accordance with the current frequency-dependent subband impairment estimate in accordance with the first message including the command to maintain the current frequency-dependent subband impairment estimate, or an update to the current frequency-dependent subband impairment estimate in accordance with the first message including the command to update the current frequency-dependent subband impairment estimate.

Some other aspects of the present disclosure are directed to a UE including one or more processors, and one or more memories coupled with the one or more processors and storing processor-executable code that, when executed by the one or more processors, is configured to cause the UE to receive, from a network node, a first message including a command to update a current frequency-dependent subband impairment estimate or a command to maintain the current frequency-dependent subband impairment estimate. Execution of the processor-executable code further causes the UE to cancel a frequency-dependent subband impairment in accordance with receiving the first message. The cancelling may be in accordance with the current frequency-dependent subband impairment estimate in accordance with the first message including the command to maintain the current frequency-dependent subband impairment estimate, or an update to the current frequency-dependent subband impairment estimate in accordance with the first message including the command to update the current frequency-dependent subband impairment estimate.

In some aspects of the present disclosure, a method for wireless communication by a network node includes learning a variation rate associated with a frequency-dependent subband impairment. The method further includes receiving a first message indicating a capability of a UE to cancel the frequency-dependent subband impairment. The method also includes transmitting, from the network node, a second message indicating a command to update or maintain a current frequency-dependent subband impairment estimate in accordance with the variation rate and the UE being capable of canceling the frequency-dependent subband impairment.

Some other aspects of the present disclosure are directed to an apparatus including means for learning a variation rate associated with a frequency-dependent subband impairment. The apparatus further includes means for receiving a first message indicating a capability of a UE to cancel the frequency-dependent subband impairment. The apparatus also includes means for transmitting, from the network node, a second message indicating a command to update or maintain a current frequency-dependent subband impairment estimate in accordance with the variation rate and the UE being capable of canceling the frequency-dependent subband impairment.

In some other aspects of the present disclosure, a non-transitory computer-readable medium with non-transitory program code recorded thereon is disclosed. The program code is executed by one or more processors and includes program code to learn a variation rate associated with a frequency-dependent subband impairment. The program code further includes program code to receive a first message indicating a capability of a UE to cancel the frequency-dependent subband impairment. The program code also includes program code to transmit, from the network node, a second message indicating a command to update or maintain a current frequency-dependent subband impairment estimate in accordance with the variation rate and the UE being capable of canceling the frequency-dependent subband impairment.

Some other aspects of the present disclosure are directed to a network node including one or more processors, and one or more memories coupled with the one or more processors and storing processor-executable code that, when executed by the one or more processors, is configured to cause the network node to learn a variation rate associated with a frequency-dependent subband impairment Execution of the processor-executable code further causes the network node to receive a first message indicating a capability of a UE to cancel the frequency-dependent subband impairment. Execution of the processor-executable code also causes the network node to transmit, from the network node, a second message indicating a command to update or maintain a current frequency-dependent subband impairment estimate in accordance with the variation rate and the UE being capable of canceling the frequency-dependent subband impairment.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a block diagram illustrating an example disaggregated base station architecture, in accordance with various aspects of the present disclosure.

FIG. 4 is a timing diagram illustrating an example for estimating a frequency-dependent subband impairment, in accordance with various aspects of the present disclosure.

FIG. 5 is a block diagram illustrating an example wireless communication device that supports selectively updating a frequency-dependent subband impairment estimate, in accordance with various aspects of the present disclosure.

FIG. 6 is a flow diagram illustrating an example of a process for selectively updating a frequency-dependent subband impairment estimate by a UE, in accordance with various aspects of the present disclosure.

FIG. 7 is a block diagram illustrating an example wireless communication device that supports selectively commanding a UE to update a frequency-dependent subband impairment estimate, in accordance with various aspects of the present disclosure.

FIG. 8 is a flow diagram illustrating an example of a process performed by a network device, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G, 4G, and/or 6G technologies.

A mismatch between in-phase (I) and quadrature (Q) components (“I/Q mismatch”) of a signal may cause a portion of the signal to leak into a sideband or subband, creating a residual band. The residual band may be an example of a frequency-dependent subband impairment, such as a frequency-dependent residual sideband (FDRSB). In some cases, the I/Q mismatch may vary based on a frequency of the signal, therefore, the subband impairment may be frequency-dependent. In some cases, the frequency-dependent subband impairment may interfere with a downlink signal, causing distortion or interference, which may degrade the quality of wireless communications. In some such cases, the interference may increase as a carrier frequency increases. The frequency-dependent subband impairment may also increase as a number of transmission antennas increases at the network node. In some examples, a network node may attempt to maintain a frequency-dependent subband impairment level below an impairment threshold to enable the transmission of low-order quadrature amplitude modulation (QAM) symbols. Additionally, or alternatively, a receiver, such as a user equipment (UE), may attempt to estimate and cancel or reduce the frequency-dependent subband impairment. In some cases, UE cancellation or reduction of frequency-dependent subband impairments may enable superQAM transmissions (for example, up to 16,000 QAM).

A process for cancelling or reducing a frequency-dependent subband impairment such as an I/Q mismatch may begin with a UE estimating the frequency-dependent subband impairment in accordance with measurements performed on one or more pilot signals. The UE may then cancel or reduce the estimated frequency-dependent subband impairment from subsequently received downlink signals. In conventional systems, the UE may estimate the frequency-dependent subband impairment for each downlink slot. However, estimating a frequency-dependent subband impairment at each of multiple downlink slots may increase resource use at the UE beyond acceptable levels. In most cases, the frequency-dependent subband impairment may have little to no variance across consecutive slots, thus rendering a per-slot estimation unnecessary, redundant, and/or avoidable. As an example, the frequency-dependent subband impairment may vary once every second, such that the frequency-dependent subband impairment may remain constant for up to 8,000 slots in accordance with millimeter wave (mmWave) numerologies. Under these circumstances, using only one out of the 8,000 slots for estimating the frequency-dependent subband impairment may eliminate 7,999 unnecessary estimations.

Aspects of the present disclosure are directed to reducing (for example. minimizing) a frequency-dependent subband impairment estimation rate. In some examples, a network node may receive, from a UE, a first message indicating a capability of the UE to cancel a frequency-dependent subband impairment. The network node may then selectively command the UE to update a current frequency-dependent subband impairment estimate. For example, in each slot of a group of slots, the network node may transmit a respective second message indicating either a command to maintain a respective current frequency-dependent subband impairment estimate or a command to update the current frequency-dependent subband impairment estimate. In some examples, the second message indicates the command to update the current frequency-dependent subband impairment estimate in accordance with a difference between a current temperature at the network node and a previous temperature at the network node being greater than a temperature threshold, an update to one or more transmission antennas at the network node, and/or a periodic schedule. In some examples, the current frequency-dependent subband impairment estimate may be an initial frequency-dependent subband impairment estimate in association with the UE establishing an initial connection with the network node. The UE may cancel or reduce the frequency-dependent subband impairment in a downlink signal in accordance with receiving the second message. In some examples, the frequency-dependent subband impairment may be cancelled or reduced in accordance with the current frequency-dependent subband impairment estimate in association with the second message indicating the command to maintain the current frequency-dependent subband impairment estimate. In some other examples, the frequency-dependent subband impairment may be cancelled or reduced in accordance with an update to the current frequency-dependent subband impairment estimate in association with the second message indicating the command to update the current frequency-dependent subband impairment estimate.

Particular aspects of the subject matter described in this disclosure can be implemented to realize one or more of the following potential advantages. In some examples, the described techniques of selectively commanding a UE to update a current frequency-dependent subband impairment estimate reduces unnecessary or redundant frequency-dependent subband impairment estimates at the UE. Reducing redundant frequency-dependent subband impairment estimates at the UE reduces resource use at the UE, which may decrease network latency and improve UE battery life.

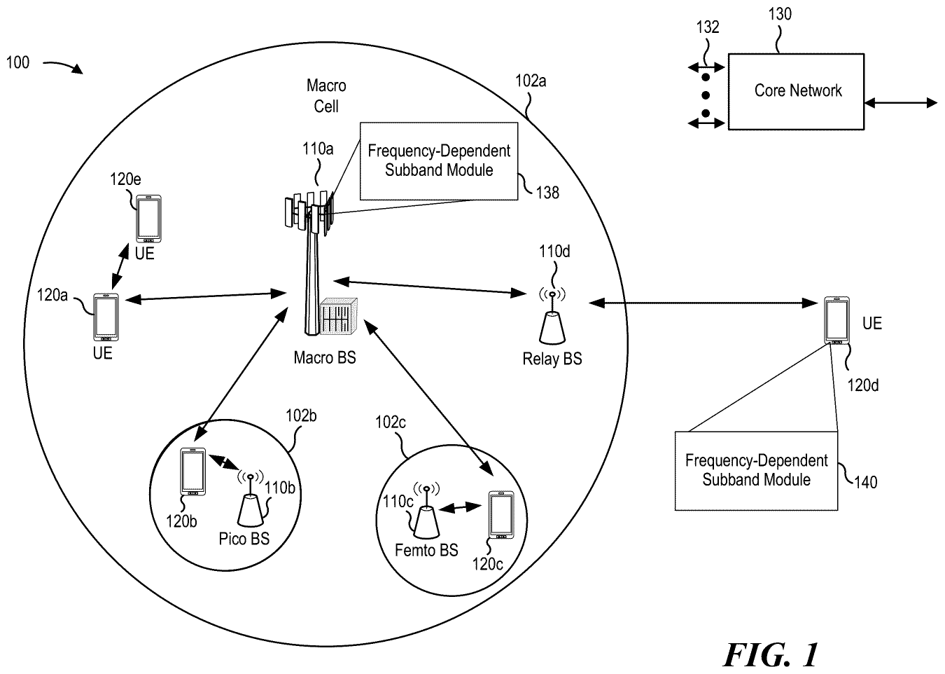

FIG. 1 is a diagram illustrating a network 100 in which aspects of the present disclosure may be practiced. The network 100 may be a 5G or NR network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G Node B, an access point, a transmit and receive point (TRP), a network node, a network entity, and/or the like. A base station can be implemented as an aggregated base station, as a disaggregated base station, an integrated access and backhaul (IAB) node, a relay node, a sidelink node, etc. The base station can be implemented in an aggregated or monolithic base station architecture, or alternatively, in a disaggregated base station architecture, and may include one or more of a central unit (CU), a distributed unit (DU), a radio unit (RU), a near-real time (near-RT) RAN intelligent controller (RIC), or a non-real time (non-RT) RIC.

Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (for example, several kilometers in radius) and may allow unrestricted access by UEs with service subscription. A pico cell may cover a relatively small geographic area and may allow unrestricted access by UEs with service subscription. A femto cell may cover a relatively small geographic area (for example, a home) and may allow restricted access by UEs having association with the femto cell (for example, UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (for example, three) cells. The terms “eNB,” “base station,” “NR BS,” “gNB,” “AP,” “Node B,” “5G NB,” “TRP,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (for example, a BS or a UE) and send a transmission of the data to a downstream station (for example, a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types (for example, macro BSs, pico BSs, femto BSs, relay BSs, and/or the like). These different types of BSs may have different transmit power levels, different coverage areas, and different impact on interference in the wireless network 100. For example, macro BSs may have a high transmit power level (for example, 5 to 40 watts) whereas pico BSs, femto BSs, and relay BSs may have lower transmit power levels (for example, 0.1 to 2 watts).

As an example, the BSs 110 (shown as BS 110a, BS 110b, BS 110c, and BS 110d) and the core network 130 may exchange communications via backhaul links 132 (for example, S1, etc.). Base stations 110 may communicate with one another over other backhaul links (for example, X2, etc.) either directly or indirectly (for example, through core network 130).

The core network 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to the network operator's IP services. The operator's IP services may include the Internet, the Intranet, an IP multimedia subsystem (IMS), and a packet-switched (PS) streaming service.

The core network 130 may provide user authentication, access authorization, tracking. IP connectivity, and other access, routing, or mobility functions. One or more of the base stations 110 or access node controllers (ANCs) may interface with the core network 130 through backhaul links 132 (for example, S1, S2, etc.) and may perform radio configuration and scheduling for communications with the UEs 120. In some configurations, various functions of each access network entity or base station 110 may be distributed across various network devices (for example, radio heads and access network controllers) or consolidated into a single network device (for example, a base station 110).

UEs 120 (for example, 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (for example, smart ring, smart bracelet)), an entertainment device (for example, a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a protocol data unit (PDU) session for a network slice. In some cases, the UE 120 may select a network slice based on an application or subscription service. By having different network slices serving different applications or subscriptions, the UE 120 may improve its resource utilization in the wireless network 100, while also satisfying performance specifications of individual applications of the UE 120. In some cases, the network slices used by UE 120 may be served by an AMF (not shown in FIG. 1) associated with one or both of the base station 110 or core network 130. In addition, session management of the network slices may be performed by an access and mobility management function (AMF).

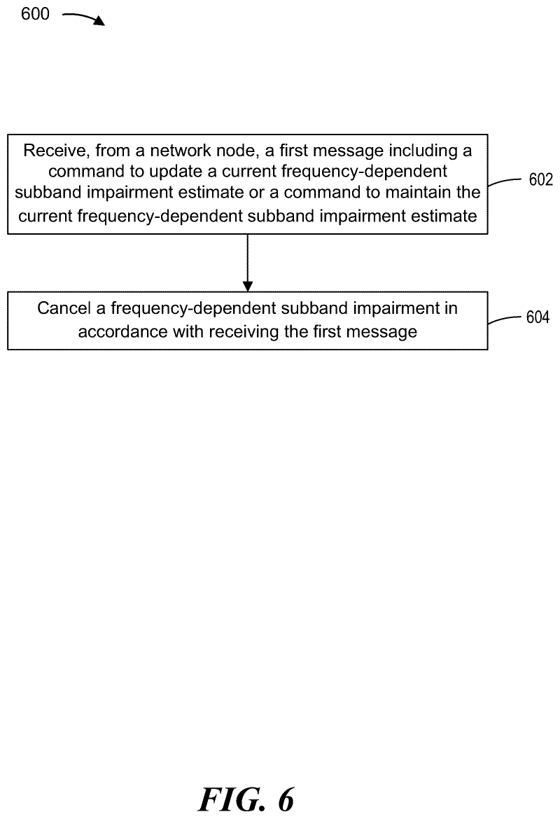

The UEs 120 may include a frequency-dependent subband module 140. For brevity, only one UE 120d is shown as including the frequency-dependent subband module 140. The frequency-dependent subband module 140 may perform one or more operations, such as one or more operations of the process 600 described with reference to FIG. 6.

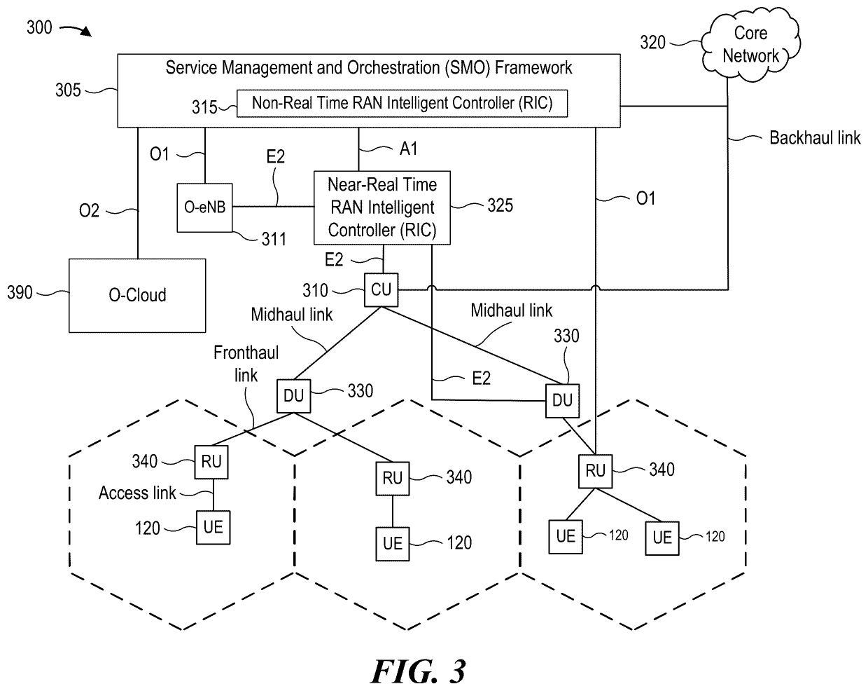

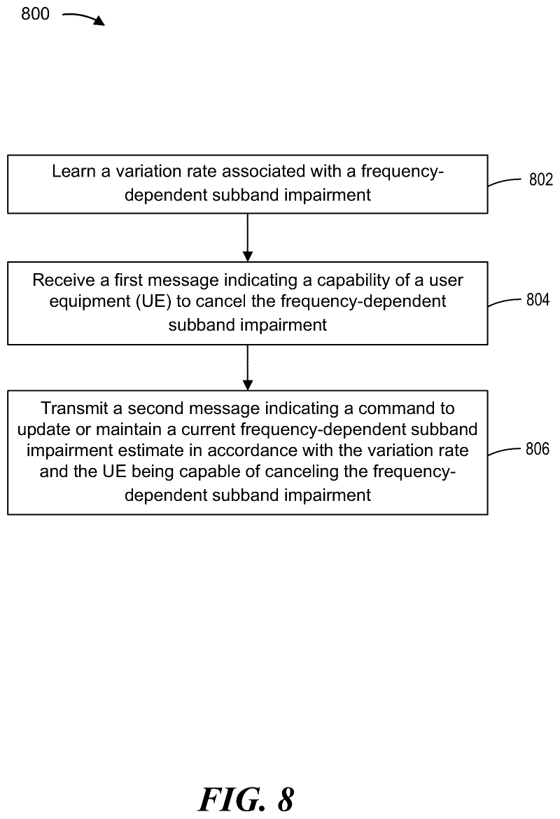

The core network 130 or the base stations 110 or any other network device (for example, as seen in FIG. 3) may include a frequency-dependent subband module 138. The frequency-dependent subband module 138 may perform one or more operations, such as one or more operations of the process 800 described with reference to FIG. 8.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (for example, remote device), or some other entity. A wireless node may provide, for example, connectivity for or to a network (for example, a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (for example, shown as UE 120a and UE 120e) may communicate directly using one or more sidelink channels (for example, without using a base station 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (for example, a system information block (SIB).

As indicated above, FIG. 1 is provided merely as an example. Other examples may differ from what is described with regard to FIG. 1.

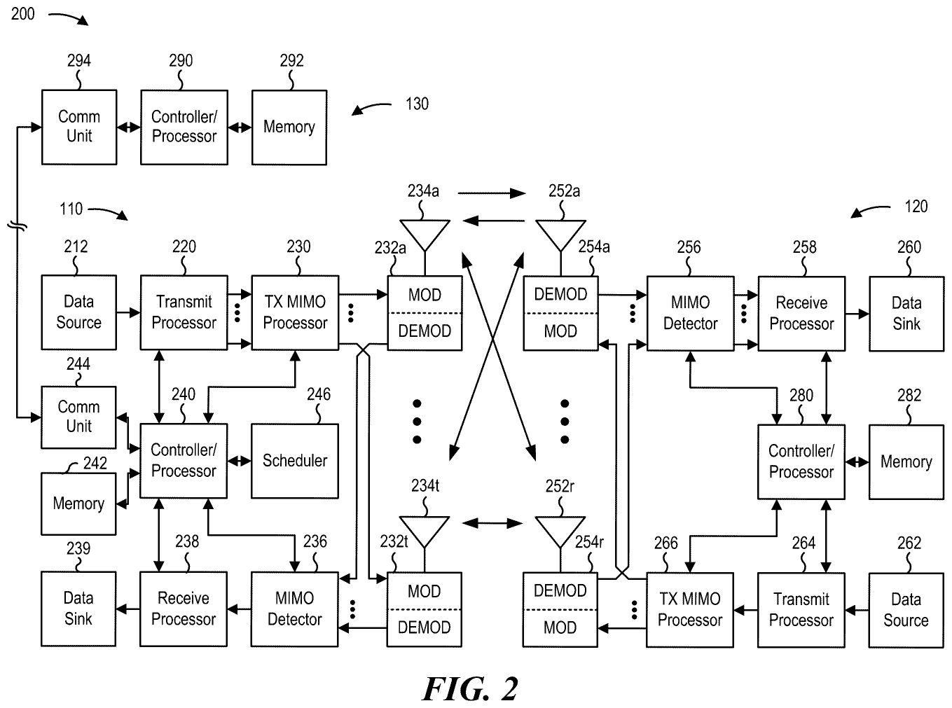

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (for example, encode and modulate) the data for each UE based at least in part on the MCS(s) selected for the UE, and provide data symbols for all UEs. Decreasing the MCS lowers throughput but increases reliability of the transmission. The transmit processor 220 may also process system information (for example, for semi-static resource partitioning information (SRPI) and/or the like) and control information (for example, CQI requests, grants, upper layer signaling, and/or the like) and provide overhead symbols and control symbols. The transmit processor 220 may also generate reference symbols for reference signals (for example, the cell-specific reference signal (CRS)) and synchronization signals (for example, the primary synchronization signal (PSS) and secondary synchronization signal (SSS)). A transmit (TX) multiple-input multiple-output (MIMO) processor 230 may perform spatial processing (for example, precoding) on the data symbols, the control symbols, the overhead symbols, and/or the reference symbols, if applicable, and may provide T output symbol streams to T modulators (MODs) 232a through 232t. Each modulator 232 may process a respective output symbol stream (for example, for orthogonal frequency division multiplexing (OFDM) and/or the like) to obtain an output sample stream. Each modulator 232 may further process (for example, convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (for example, filter, amplify, downconvert, and digitize) a received signal to obtain input samples. Each demodulator 254 may further process the input samples (for example, for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (for example, demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (for example, for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (for example, for discrete Fourier transform spread OFDM (DFT-s-OFDM), CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

The controller/processor 240 of the base station 110, the controller/processor 280 of the UE 120, and/or any other component(s) of FIG. 2 may perform one or more techniques associated with estimating a frequency-dependent impairment as described in more detail elsewhere. For example, the controller/processor 240 of the base station 110, the controller/processor 280 of the UE 120, and/or any other component(s) of FIG. 2 may perform or direct operations of, for example, the processes of FIGS. 6 and 8 and/or other processes as described. Memories 242 and 282 may store data and program codes for the base station 110 and UE 120, respectively. A scheduler 246 may schedule UEs for data transmission on the downlink and/or uplink.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), an evolved NB (eNB), an NR BS, 5G NB, an access point (AP), a transmit and receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (for example, a virtual central unit (VCU), a virtual distributed unit (VDU), or a virtual radio unit (VRU)).

Base station-type operations or network designs may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In some cases, different types of devices supporting different types of applications and/or services may coexist in a cell. Examples of different types of devices include UE handsets, customer premises equipment (CPEs), vehicles, Internet of Things (IoT) devices, and/or the like. Examples of different types of applications include ultra-reliable low-latency communications (URLLC) applications, massive machine-type communications (mMTC) applications, enhanced mobile broadband (eMBB) applications, vehicle-to-anything (V2X) applications, and/or the like. Furthermore, in some cases, a single device may support different applications or services simultaneously.

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real time (near-RT) RAN intelligent controller (RIC) 325 via an E2 link, or a non-real time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units (for example, the CUS 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (for example, central unit-user plane (CU-UP)), control plane functionality (for example, central unit-control Plane (CU-CP)), or a combination thereof. In some implementations, the CU 310 can be logically split into one or more CU-UP units and one or more CU-CP units. The CU-UP unit can communicate bi-directionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the Third Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO framework 305 may be configured to support RAN deployment and provisioning of non-virtualized and virtualized network elements. For non-virtualized network elements, the SMO framework 305 may be configured to support the deployment of dedicated physical resources for RAN coverage requirements, which may be managed via an operations and maintenance interface (such as an O1 interface). For virtualized network elements, the SMO framework 305 may be configured to interact with a cloud computing platform (such as an open cloud (O-cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and near-RT RICs 325. In some implementations, the SMO framework 305 can communicate with a hardware aspect of a 4G RAN, such as an open eNB (O-eNB) 311, via an O1 interface. Additionally, in some implementations, the SMO framework 305 can communicate directly with one or more RUs 340 via an O1 interface. The SMO framework 305 also may include a non-RT RIC 315 configured to support functionality of the SMO framework 305.

The non-RT RIC 315 may be configured to include a logical function that enables non-real-time control and optimization of RAN elements and resources, artificial intelligence/machine learning (AI/ML) workflows including model training and updates, or policy-based guidance of applications/features in the near-RT RIC 325. The non-RT RIC 315 may be coupled to or communicate with (such as via an A1 interface) the near-RT RIC 325. The near-RT RIC 325 may be configured to include a logical function that enables near-real-time control and optimization of RAN elements and resources via data collection and actions over an interface (such as via an E2interface) connecting one or more CUs 310, one or more DUs 330, or both, as well as the O-eNB 311, with the near-RT RIC 325.

In some implementations, to generate AI/ML models to be deployed in the near-RT RIC 325, the non-RT RIC 315 may receive parameters or external enrichment information from external servers. Such information may be utilized by the near-RT RIC 325 and may be received at the SMO framework 305 or the non-RT RIC 315 from non-network data sources or from network functions. In some examples, the non-RT RIC 315 or the near-RT RIC 325 may be configured to tune RAN behavior or performance. For example, the non-RT RIC 315 may monitor long-term trends and patterns for performance and employ AI/ML models to perform corrective actions through the SMO framework 305 (such as reconfiguration via O1) or via creation of RAN management policies (such as A1 policies).

A mismatch between in-phase (I) and quadrature (Q) components of a signal may result in a frequency-dependent subband impairment, such as a frequency-dependent residual side band. The frequency-dependent subband impairment may interfere with wireless communication, and the interference may increase as a carrier frequency increases. The frequency-dependent subband impairment may also increase as a number of transmission antennas increase at the network node. In some cases, a network node may maintain a frequency-dependent subband impairment level below a threshold to enable the transmission of low order QAM. Additionally, or alternatively, a receiver, such as a UE, may estimate and cancel the frequency-dependent subband impairment. Cancellation of the frequency-dependent subband impairment, by the UE, may enable superQAM transmissions (for example, up to 16,000 QAM).

A process for cancelling the frequency-dependent subband impairment begins with the UE estimating the frequency-dependent subband impairment in accordance with one or more pilot signals measurements. The UE may then cancel, or reduce, the estimated frequency-dependent subband impairment from downlink signals. In conventional systems, the UE may estimate the frequency-dependent subband impairment for each downlink slot. The procedure of estimating and cancelling the frequency-dependent subband impairment, at each downlink slot, may increase UE complexity and increase latency for each downlink slot. The frequency-dependent subband impairment may have little, to no, variance between consecutive slots, thus rendering a per-slot estimation redundant and avoidable. As an example, the frequency-dependent subband impairment may vary due to a temperature change in a remote radio head (RRH) associated with a network node.

An I/Q modulator may be integrated with the RRH that is placed on a rooftop or atop a cell tower. Generally, RRHs operate within an approximate temperature range of −40 to +55 degrees Celsius (e.g., −40 to +131 degrees Fahrenheit (F.)), such that the RRH may reliably function under extreme cold or hot conditions. Variations in a temperature of the RRH may be attributed to one or more factors, such as RRH design, environmental conditions, and/or cooling mechanisms. For example, due to an installation location on a cell tower or rooftop, an RRH may experience diverse weather conditions, including heat from the sun. Without adequate cooling measures, the internal RRH temperature can increase beyond a threshold temperature (e.g., 131° F.). Reducing the temperature of the RRH may improve performance of the RRH. Therefore, the RRH may include a cooling system, such as fans, heat sinks, and/or heat exchangers. The cooling system may disperse heat from the RRH's electronic components, keeping the internal temperature within acceptable boundaries.

A temperature variation at the I/Q modulator may result in variations of the frequency-dependent subband impairment. Still, temperature variations are not the sole cause of variations in the frequency-dependent subband impairment. Events such as the network node updating one or more transmission antennas, a change in a sector, and/or other changes at the RRH may also cause frequency-dependent subband impairment variations. In such instances, it may be necessary to re-estimate the frequency-dependent subband impairment. In most cases, the frequency-dependent subband impairment may change approximately once every second, thus rendering per-slot frequency-dependent subband impairment estimations unnecessary.

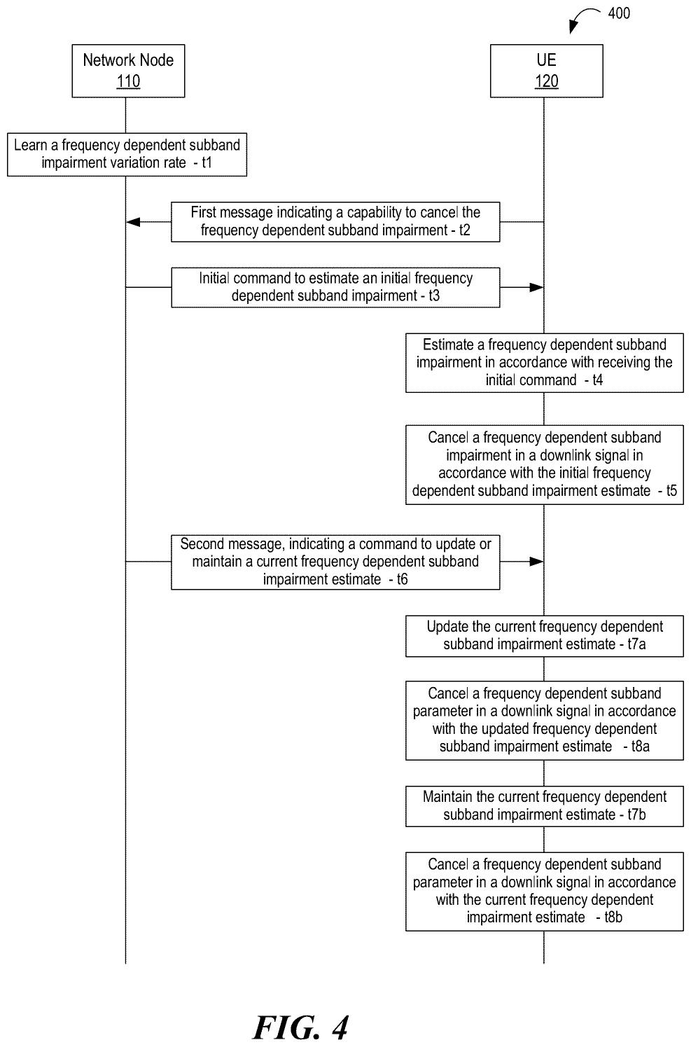

Aspects of the present disclosure are directed to reducing (for example, minimizing) a frequency-dependent subband impairment estimation rate. FIG. 4 is a timing diagram 400 illustrating an example for estimating a frequency-dependent subband impairment, in accordance with various aspects of the present disclosure. As shown in the example of FIG. 4, a network node 110 may communicate with a UE 120

In the example of FIG. 4, at time t1, the network node 110 learns a frequency-dependent subband impairment variation rate for transmissions. Additionally, at time t1, the network node 110 may determine a schedule and/or one or more triggers for commanding the UE 120 to update a frequency-dependent subband impairment estimate. The one or more triggers may include, but are not limited to a difference between a current temperature and a previous temperature being greater than T degrees and/or a change in one or more transmission antennas. The previous temperature may correspond to a time when a previous command for updating the frequency-dependent subband impairment estimate was transmitted to the UE 120. The schedule may be a per slot schedule, such as a periodic schedule. For example, the network node 110 may command the UE 120 to update once every N slots regardless of whether one or more other triggers were activated. In some examples, the operations described with reference to time t1 may be performed offline. For example, the variation rate may be learned offline. Additionally, the T degrees and N slots may be learned offline.

At time t2, the network node 110 may receive, from the UE 120, a first message indicating a capability of the UE 120 to cancel the frequency-dependent subband variations. The first message may be an RRC message or another type of control message. In some examples, the first message may be received during a process for establishing a connection between the UE 120 and the network node 110. In accordance with establishing the connection with the UE 120 and also in accordance with the UE 120 having the capability to cancel the frequency-dependent subband impairment, the network node 110 may transmit, to the UE 120 at time t3, an initial command to estimate an initial frequency-dependent subband impairment. At time t4, the UE 120 may estimate a frequency-dependent subband impairment in accordance with receiving the initial command. In some examples, the frequency-dependent subband impairment may be associated with one or more measurements associated with one or more pilot symbols. For example, the network node 110 may transmit, to the UE 120, one or more pilot symbols. In this example, the UE 120 may measure the one or more pilot symbols, and the frequency-dependent subband impairment estimate may be associated with the measurements of the one or more pilot symbols. At time t5, the UE 120 may cancel a frequency-dependent subband impairment in a downlink signal in accordance with the initial frequency-dependent subband impairment estimate.

After transmitting the second message, the network node 110 may transmit, to the UE 120 at time t6, a second message, indicating a command to update or maintain a current frequency-dependent subband impairment estimate (for example, the initial frequency-dependent subband impairment). The command may be associated with a single bit that indicates whether to update or maintain the current frequency-dependent subband impairment estimate. The current frequency-dependent subband impairment estimate may be maintained in accordance with the single bit having a first value and the current frequency-dependent subband impairment estimate may be updated in accordance with the single bit having a second value. The second message and the initial command may be transmitted via a downlink control channel, such as the physical downlink control channel (PDCCH).

In some examples, at time t7a, the UE 120 may update the current frequency-dependent subband impairment estimate in accordance with the second message indicating the command to update the current frequency-dependent subband impairment estimate. In such examples, at time t8a, the UE 120 may cancel a frequency-dependent subband impairment in a downlink signal in accordance with the updated initial frequency-dependent subband impairment estimate. In some other examples, at time t7b, the UE 120 may maintain the current frequency-dependent subband impairment estimate in accordance with the second message, indicating the command to maintain the current frequency-dependent subband impairment estimate (for example, the initial frequency-dependent subband impairment). In such examples, at time t8b, the UE 120 may cancel the frequency-dependent subband impairment in the downlink signal in accordance with the current initial frequency-dependent subband impairment estimate. In some examples, cancelling the frequency-dependent subband impairment includes partially canceling the frequency-dependent subband impairment.

As discussed, the command to update the current frequency-dependent subband impairment estimate may be transmitted in accordance with a periodic schedule (for example, once every N slots) or in response to one or more trigger conditions. The one or more trigger conditions may include a difference between a current temperature at the network node 110 and a previous temperature at the network node 110 being greater than a temperature threshold and/or a change in one or more transmission antennas at the network node 110. The previous temperature may be associated with a time period corresponding to the network node 110 transmitting, to the UE 120, a third message indicating another command to update a previous frequency-dependent subband impairment. In this example, the third message is transmitted prior to the second message transmitted at time t6.

As discussed, at time t1, the network node 110 may learn a changing rate of the frequency-dependent subband impairment operations during an offline stage. In some examples, the measurements may be performed by a manufacturer (for example, at a factory) before a deployment stage. The measurements may be performed with lab equipment such as a spectrum analyzer. In some examples, multiple measurements may be obtained, with a range of working temperatures, to determine a variance of the frequency-dependent subband impairment with regard to a change in temperature and time.

In some examples, during the offline learning stage, the measurement process may include two primary steps, and each step may include recording a half band signal from different sides of a bandwidth. In such examples, a step function u(ƒ) may be defined, where u(ƒ)=1 for ƒ≥0 and (ƒ)=0 for ƒ<0, where the variable ƒ represents a frequency. In such examples, the step function u(ƒ) may be used to select certain frequency ranges (either positive or negative) for the measurements. During the offline learning stage, a first measurement m₁(ƒ) may be used to record a half band signal that is allocated in a left side of the bandwidth, denoted as u(−ƒ), which maintains a constant value of 0 [dB] over all subcarriers. The spectrum analyzer may show: m₁(ƒ)=K₁ (ƒ)·u(−ƒ)+K₂(ƒ)u(ƒ). A second measurement m₂(ƒ) may be used to record a half band signal that is allocated in a right side of the bandwidth, denoted as u(ƒ), which maintains a constant value of 0 [dB] over all subcarriers. The spectrum analyzer may show: m₂(ƒ)=K₁(ƒ)·u(ƒ)+K₂(ƒ)u(−ƒ). Frequency-dependent components (K₁ (ƒ) and K₂ (ƒ)) related to the in-phase (I) and quadrature (Q) components of the frequency-dependent subband impairment may be measured after obtaining the measurements of each half band signal (m₁ (ƒ) and m₂ (ƒ)). In such examples, K₁(ƒ)=m₁(ƒ)u(−ƒ)+m₂(ƒ)u(ƒ) and K₂(ƒ)=m₂(ƒ)u(−ƒ)+m₁(ƒ)u(ƒ). K₁(ƒ) and K₂(ƒ) are frequency-dependent coefficients that reflect the frequency-dependent characteristics of the I/Q imbalance.

As discussed, the frequency-dependent subband impairment may be estimated based on measurements of one or more pilot symbols, such as a demodulation reference signal (DMRS) or a sounding reference signal (SRS). In some examples, a channel H may be estimated based on the one or more pilot symbols. In such examples, the channel estimate \tilde{H}(ƒ)=H(ƒ)*diag(K₁(ƒ)). The diag( ) function returns a square diagonal matrix with the elements of vector associated with frequency-dependent coefficients K₁(ƒ) on a main diagonal. The frequency-dependent subband impairment estimate Φ(ƒ) may be estimated in accordance with the estimated channel \tilde{H}(ƒ), where

$$Φ ( f ) = \frac{{K}_{2} ( f )}{{K}_{1} ( f )} .$$

Assuming the frequency-dependent subband impairment estimate Φ(ƒ) remains constant over a number of subcarriers, an average value of the frequency-dependent subband impairment over these subcarriers may be calculated. The average value over the subcarriers may be referred to as averaging the frequency-dependent subband impairment curve. Specifically, for every subcarrier indexed by j and l (where l and j range from 1 to N), the frequency-dependent subband impairment estimate Φ(ƒ) is the same (for example, Φ(ƒₗ)=Φ(ƒⱼ)=Φ(ƒ)∀1≤j, l≤N).

After averaging the frequency-dependent subband impairment curve, a smooth and continuous estimate of the frequency-dependent subband impairment curve across all subcarriers may be obtained by interpolating over all the subcarriers. This interpolated curve will provide a more accurate and detailed representation of the frequency-dependent subband impairment variation over the entire frequency range. Once the frequency-dependent subband impairment curve is estimated with interpolation, the next step is to correct or remove the frequency-dependent subband impairment from a received signal in accordance with the frequency-dependent subband impairment estimate Φ(ƒ). For example, the UE 120 may use the frequency-dependent subband impairment estimate Φ(ƒ) to counteract the effect of the frequency-dependent subband impairment on the signal.

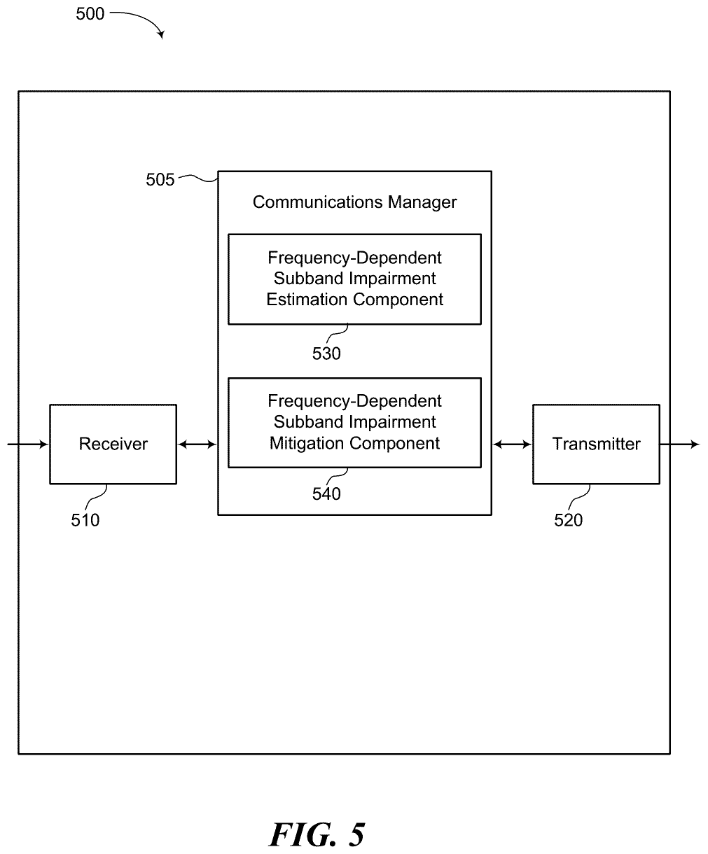

FIG. 5 is a block diagram illustrating an example wireless communication device that supports selectively updating a frequency-dependent subband impairment estimate, in accordance with some aspects of the present disclosure. The device 500 may be an example of aspects of a UE 120 described with reference to FIGS. 1, 2, 3, and 4. The wireless communications device 500 may include a receiver 510, a communications manager 505, a transmitter 520, a frequency-dependent subband impairment estimation component 530, and a frequency-dependent subband impairment mitigation component 540, which may be in communication with one another (for example, via one or more buses). In some examples, the wireless communications device 500 is configured to perform operations, including operations of the process 600 described below with reference to FIG. 6.

In some examples, the wireless communications device 500 can include a chip, chipset, package, or device that includes at least one processor and at least one modem (for example, a 5G modem or other cellular modem). In some examples, the communications manager 505, or its sub-components, may be separate and distinct components. In some examples, at least some components of the communications manager 505 are implemented at least in part as software stored in a memory. For example, portions of one or more of the components of the communications manager 505 can be implemented as non-transitory code executable by the processor to perform the functions or operations of the respective component.

The receiver 510 may receive one or more of reference signals (for example, periodically configured channel state information reference signals (CSI-RSs), aperiodically configured CSI-RSs, or multi-beam-specific reference signals), synchronization signals (for example, synchronization signal blocks (SSBs)), control information and data information, such as in the form of packets, from one or more other wireless communications devices via various channels including control channels (for example, a physical downlink control channel (PDCCH), physical uplink control channel (PUCCH), or physical shared control channel (PSCCH)) and data channels (for example, a physical downlink shared channel (PDSCH), physical sidelink shared channel (PSSCH), a physical uplink shared channel (PUSCH)). The other wireless communications devices may include, but are not limited to, a base station 110 described with reference to FIGS. 1, 2, and 4, a DU 330, an RU 340, or a CU 310 described with reference to FIG. 3.

The received information may be passed on to other components of the device 500. The receiver 510 may be an example of aspects of the receive processor 258 described with reference to FIG. 2. The receiver 510 may include a set of radio frequency (RF) chains that are coupled with or otherwise utilize a set of antennas (for example, the set of antennas may be an example of aspects of the antennas 252 described with reference to FIG. 2).

The transmitter 520 may transmit signals generated by the communications manager 505 or other components of the wireless communications device 500. In some examples, the transmitter 520 may be collocated with the receiver 510 in a transceiver. The transmitter 520 may be an example of aspects of the transmit processor 264 described with reference to FIG. 2. The transmitter 520 may be coupled with or otherwise utilize a set of antennas (for example, the set of antennas may be an example of aspects of the antennas 252 described with reference to FIG. 2), which may be antenna elements shared with the receiver 510. In some examples, the transmitter 520 is configured to transmit control information in a PUCCH, PSCCH, or PDCCH and data in a physical uplink shared channel (PUSCH), PSSCH, or PDSCH.

The communications manager 505 may be an example of aspects of the controller/processor 280 described with reference to FIG. 2. The communications manager 505 may include the frequency-dependent subband impairment estimation component 530 and the frequency-dependent subband impairment mitigation component 540. In some examples, working in conjunction with the receiver 510 the frequency-dependent subband impairment estimation component 530 receives, from a network node, a first message including a command to update a current frequency-dependent subband impairment estimate or a command to maintain the current frequency-dependent subband impairment estimate. Additionally, working in conjunction with one or both of the frequency-dependent subband impairment estimation component 530 or the receiver 510, the frequency-dependent subband impairment mitigation component 540 may cancel a frequency-dependent subband impairment in accordance with receiving the first message. The cancelling may be in accordance with the current frequency-dependent subband impairment estimate in accordance with the first message including the command to maintain the current frequency-dependent subband impairment estimate, or an update to the current frequency-dependent subband impairment estimate in accordance with the first message including the command to update the current frequency-dependent subband impairment estimate. In some examples, the cancelling may include partial cancelling.

FIG. 6 is a flow diagram illustrating an example process 600 performed by a UE, in accordance with some aspects of the present disclosure. The UE may be an example of a UE 120 described with reference to FIGS. 1, 2, 3, and 4. The example process 600 is an example of selectively refreshing a frequency-dependent subband impairment estimate. As shown in FIG. 6, the process 600 begins at block 602 by receiving, from a network node, a first message including a command to update a current frequency-dependent subband impairment estimate or a command to maintain the current frequency-dependent subband impairment estimate. At block 604, the process 600 cancels a frequency-dependent subband impairment in accordance with receiving the first message. The cancelling may be in accordance with the current frequency-dependent subband impairment estimate in accordance with the first message including the command to maintain the current frequency-dependent subband impairment estimate, or an update to the current frequency-dependent subband impairment estimate in accordance with the first message including the command to update the current frequency-dependent subband impairment estimate.

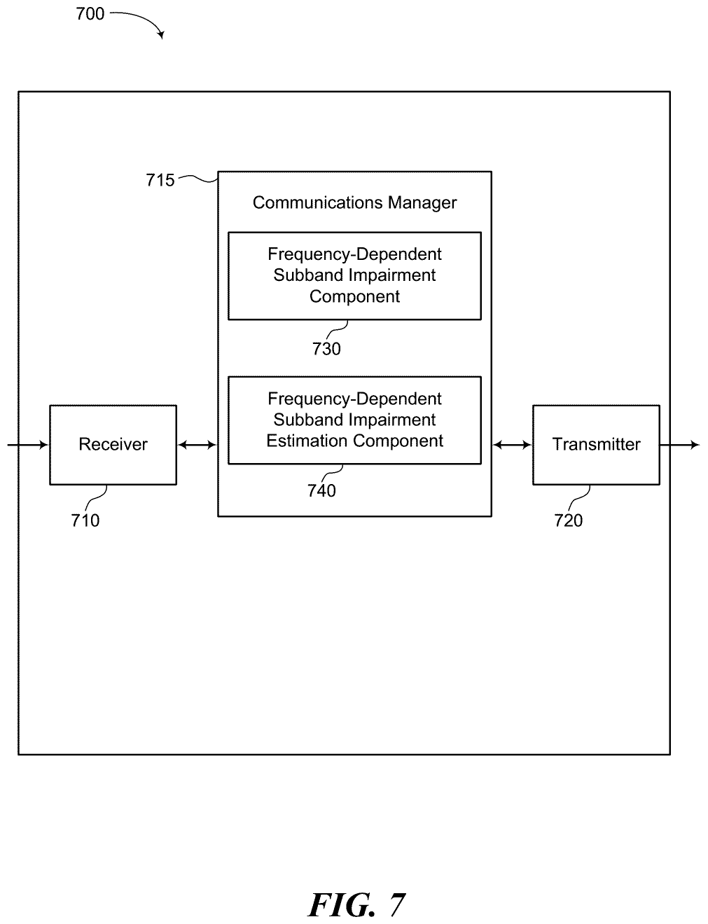

FIG. 7 is a block diagram illustrating an example wireless communication device 700 that supports selectively commanding a UE to update a frequency-dependent subband impairment estimate, in accordance with aspects of the present disclosure. The wireless communication device 700 may be an example of a base station 110 described with reference to FIGS. 1, 2, and 4, a DU 330, an RU 340, or a CU 310 described with reference to FIG. 3. The wireless communication device 700 may include a receiver 710, a communications manager 715, a frequency-dependent subband impairment component 730, frequency-dependent subband impairment estimation component 740, and a transmitter 720, which may be in communication with one another (for example, via one or more buses). In some examples, the wireless communication device 700 is configured to perform operations, including operations of the process 800 described below with reference to FIG. 8.

In some examples, the wireless communication device 700 can include a chip, system on chip (SOC), chipset, package, or device that includes at least one processor and at least one modem (for example, a 5G modem or other cellular modem). In some examples, the communications manager 715, or its sub-components, may be separate and distinct components. In some examples, at least some components of the communications manager 715 are implemented at least in part as software stored in a memory. For example, portions of one or more of the components of the communications manager 715 can be implemented as non-transitory code executable by the processor to perform the functions or operations of the respective component.

The receiver 710 may receive one or more reference signals (for example, periodically configured CSI-RSs, aperiodically configured CSI-RSs, or multi-beam-specific reference signals), synchronization signals (for example, synchronization signal blocks (SSBs)), control information, and/or data information, such as in the form of packets, from one or more other wireless communication devices via various channels including control channels (for example, a PUCCH or a PSCCH) and data channels (for example, a PUSCH or a PSSCH). The other wireless communication devices may include, but are not limited to, another base station 110, or a UE 120, described with reference to FIGS. 1, 2, 3, and 4.

The received information may be passed on to other components of the wireless communication device 700. The receiver 710 may be an example of aspects of the receive processor 238 described with reference to FIG. 2. The receiver 710 may include a set of radio frequency (RF) chains that are coupled with or otherwise utilize a set of antennas (for example, the set of antennas may be an example of aspects of the antennas 234 described with reference to FIG. 2).

The transmitter 720 may transmit signals generated by the communications manager 715 or other components of the wireless communication device 700. In some examples, the transmitter 720 may be collocated with the receiver 710 in a transceiver. The transmitter 720 may be an example of aspects of the transmit processor 220 described with reference to FIG. 2. The transmitter 720 may be coupled with or otherwise utilize a set of antennas (for example, the set of antennas may be an example of aspects of the antennas 234), which may be antenna elements shared with the receiver 710. In some examples, the transmitter 720 is configured to transmit control information in a PDCCH or a PSCCH and data in a PDSCH or PSSCH.

The communications manager 715 may be an example of aspects of the controller/processor 240 described with reference to FIG. 2. The communications manager 715 includes the frequency-dependent subband impairment component 730 and the frequency-dependent subband impairment estimation component 740. In some examples, working in conjunction with one or both of the transmitter 720 or the receiver 710, the frequency-dependent subband impairment component 730 learns a variation rate associated with a frequency-dependent subband impairment. Additionally, working in conjunction with the receiver 710, the frequency-dependent subband impairment component 730 receives a first message indicating a capability of a UE to cancel the frequency-dependent subband impairment. Furthermore, working in conjunction with one or both of the transmitter 720 or the frequency-dependent subband impairment component 730, the frequency-dependent subband impairment estimation component 740 transmits a second message indicating a command to update or maintain a current frequency-dependent subband impairment estimate in accordance with the variation rate and the UE being capable of canceling the frequency-dependent subband impairment.

FIG. 8 is a flow diagram illustrating an example of a process 800 performed by network node, in accordance with some aspects of the present disclosure. The wireless device may be an example of a base station 110 described with reference to FIGS. 1, 2, and 4, a DU 330, an RU 340, or a CU 310 described with reference to FIG. 3. The example process 800 is an example of receiving multiple PRACH transmissions from a single UE. As shown in FIG. 10, the process 800 begins at block 802, by learning a variation rate associated with a frequency-dependent subband impairment. At block 804, the process 800 receives a first message indicating a capability of a UE to cancel the frequency-dependent subband impairment. At block 806, the process 800 transmits a second message indicating a command to update or maintain a current frequency-dependent subband impairment estimate in accordance with the variation rate and the UE being capable of canceling the frequency-dependent subband impairment.

Implementation examples are described in the following numbered clauses:
Clause 1. A method for wireless communication by a UE, comprising: receiving, from a network node, a first message including a command to update a current frequency-dependent subband impairment estimate or a command to maintain the current frequency-dependent subband impairment estimate; and canceling a frequency-dependent subband impairment in accordance with receiving the first message, the cancelling being in accordance with: the current frequency-dependent subband impairment estimate in accordance with the first message including the command to maintain the current frequency-dependent subband impairment estimate, or an update to the current frequency-dependent subband impairment estimate in accordance with the first message including the command to update the current frequency-dependent subband impairment estimate.
Clause 2. The method of Clause 1, further comprising updating the current frequency-dependent subband impairment estimate in accordance with the first message including the command to update the current frequency-dependent subband impairment estimate.
Clause 3. The method of Clause 2, further comprising: receiving, from the network node, one or more pilot symbols; and measuring the one or more pilot symbols, wherein the current frequency-dependent subband impairment estimate is updated in accordance with measuring the one or more pilot symbols.
Clause 4. The method of any one of Clauses 1-3, further comprising receiving, at each slot of a group of slots, an additional respective first message including either a command to update a respective current frequency-dependent subband impairment estimate or a command to maintain a respective current frequency-dependent subband impairment estimate.
Clause 5. The method of any one of Clauses 1-4, wherein: the command to update the current frequency-dependent subband impairment estimate and the command to maintain the current frequency-dependent subband impairment estimate are associated with a same single bit that indicates whether to update or maintain the current frequency-dependent subband impairment estimate; the current frequency-dependent subband impairment estimate is maintained in accordance with the single bit having a first value; and the current frequency-dependent subband impairment estimate is updated in accordance with the single bit having a second value.
Clause 6. The method of any one of Clauses 1-5, further comprising estimating an initial frequency-dependent subband impairment in association with initializing a connection with the network node, wherein the initial frequency-dependent subband impairment estimate is the current frequency-dependent subband impairment estimate.
Clause 7. The method of any one of Clauses 1-6, wherein the first message is received in accordance with a difference between a current temperature at the network node and a previous temperature at the network node being greater than a temperature threshold, an update to one or more transmission antennas at the network node, and/or a periodic schedule.
Clause 8. The method of Clause 7, wherein the previous temperature is associated with a time period corresponding to receiving, from the network node, prior to receiving the first message, a third message indicating another command to update a previous frequency-dependent subband impairment estimate.
Clause 9. The method of any one of Clauses 1-8, further comprising transmitting, to the network node, a second message indicating a capability of the UE to cancel a frequency-dependent subband impairment.

Clause 10. A method for wireless communication by a network node, comprising: learning a variation rate associated with a frequency-dependent subband impairment; receiving a first message indicating a capability of a UE to cancel the frequency-dependent subband impairment; and transmitting a second message indicating a command to update or maintain a current frequency-dependent subband impairment estimate in accordance with the variation rate and the UE being capable of canceling the frequency-dependent subband impairment.
Clause 11. The method of Clause 10, further comprising transmitting one or more pilot symbols, wherein the current frequency-dependent subband impairment estimate is associated with the one or more pilot symbols.
Clause 12. The method of any one of Clauses 10-11, further comprising transmitting, at each slot of a group of slots, an additional respective second message including either a command to update a respective current frequency-dependent subband impairment estimate or a command to maintain a respective current frequency-dependent subband impairment estimate.
Clause 13. The method of any one of Clauses 10-12, wherein: the command to update the current frequency-dependent subband impairment estimate and the command to maintain the current frequency-dependent subband impairment estimate are associated with a same single bit that indicates whether to update or maintain the current frequency-dependent subband impairment estimate; the current frequency-dependent subband impairment estimate is maintained in accordance with the single bit having a first value; and the current frequency-dependent subband impairment estimate is updated in accordance with the single bit having a second value.
Clause 14. The method of any one of Clauses 10-13, wherein the variation rate is associated with one or more of a temperature threshold, an update to one or more transmission antennas at the network node, and/or a periodic schedule.
Clause 15. The method of Clause 14, wherein: the second message includes the command to update the current frequency-dependent subband impairment estimate in accordance with a difference between a current temperature at the network node and a previous temperature at the network node being greater than the temperature threshold; and the previous temperature is associated with a time period corresponding to transmitting, prior to transmitting the second message, a third message indicating another command to update a previous frequency-dependent subband impairment.
Clause 16. The method of Clause 15, wherein the second message includes the command to update the current frequency-dependent subband impairment estimate in accordance with the network node updating the one or more transmission antennas.
Clause 17. The method of Clause 15, wherein the second message includes the command to update the current frequency-dependent subband impairment estimate in accordance with the periodic schedule.

The foregoing disclosure provides illustration and description, but is not intended to be exhaustive or to limit the aspects to the precise form disclosed. Modifications and variations may be made in light of the above disclosure or may be acquired from practice of the aspects.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (for example, a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (for example, related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. A method for wireless communication by a user equipment (UE), comprising:
receiving, from a network node, a first message including a command to update a current frequency-dependent subband impairment estimate or a command to maintain the current frequency-dependent subband impairment estimate; and
canceling a frequency-dependent subband impairment in accordance with receiving the first message, the cancelling being in accordance with:
the current frequency-dependent subband impairment estimate in accordance with the first message including the command to maintain the current frequency-dependent subband impairment estimate, or
an update to the current frequency-dependent subband impairment estimate in accordance with the first message including the command to update the current frequency-dependent subband impairment estimate.

2. The method of claim 1, further comprising updating the current frequency-dependent subband impairment estimate in accordance with the first message including the command to update the current frequency-dependent subband impairment estimate.

3. The method of claim 2, further comprising:
receiving, from the network node, one or more pilot symbols; and
measuring the one or more pilot symbols, wherein the current frequency-dependent subband impairment estimate is updated in accordance with measuring the one or more pilot symbols.

4. The method of claim 1, further comprising receiving, at each slot of a group of slots, an additional respective first message including either a command to update a respective current frequency-dependent subband impairment estimate or a command to maintain a respective current frequency-dependent subband impairment estimate.

5. The method of claim 1, wherein:
the command to update the current frequency-dependent subband impairment estimate and the command to maintain the current frequency-dependent subband impairment estimate are associated with a same single bit that indicates whether to update or maintain the current frequency-dependent subband impairment estimate;
the current frequency-dependent subband impairment estimate is maintained in accordance with the single bit having a first value; and
the current frequency-dependent subband impairment estimate is updated in accordance with the single bit having a second value.

6. The method of claim 1, further comprising estimating an initial frequency-dependent subband impairment in association with initializing a connection with the network node, wherein the initial frequency-dependent subband impairment estimate is the current frequency-dependent subband impairment estimate.

7. The method of claim 1, wherein the first message is received in accordance with a difference between a current temperature at the network node and a previous temperature at the network node being greater than a temperature threshold, an update to one or more transmission antennas at the network node, and/or a periodic schedule.

8. The method of claim 7, wherein the previous temperature is associated with a time period corresponding to receiving, from the network node, prior to receiving the first message, a third message indicating another command to update a previous frequency-dependent subband impairment estimate.

9. The method of claim 1, further comprising transmitting, to the network node, a second message indicating a capability of the UE to cancel the frequency-dependent subband impairment.

10. A user equipment (UE), comprising:
one or more processors; and
one or more memories coupled with the one or more processors and storing processor-executable code that, when executed by the one or more processors, is configured to cause the UE to:
receive, from a network node, a first message including a command to update a current frequency-dependent subband impairment estimate or a command to maintain the current frequency-dependent subband impairment estimate; and
cancel a frequency-dependent subband impairment in accordance with receiving the first message, the cancelling being in accordance with:
the current frequency-dependent subband impairment estimate in accordance with the first message including the command to maintain the current frequency-dependent subband impairment estimate, or
an update to the current frequency-dependent subband impairment estimate in accordance with the first message including the command to update the current frequency-dependent subband impairment estimate.

11. The UE of claim 10, wherein execution of the processor-executable code further causes the UE to update the current frequency-dependent subband impairment estimate in accordance with the first message including the command to update the current frequency-dependent subband impairment estimate.

12. The UE of claim 11, wherein:
execution of the processor-executable code further causes the UE to:
receive, from the network node, one or more pilot symbols; and
measure the one or more pilot symbols; and
the current frequency-dependent subband impairment estimate is updated in accordance with measuring the one or more pilot symbols.

13. The UE of claim 10, wherein execution of the processor-executable code further causes the UE to receive, at each slot of a group of slots, an additional respective first message including either a command to update a respective current frequency-dependent subband impairment estimate or a command to maintain a respective current frequency-dependent subband impairment estimate.

14. The UE of claim 10, wherein:
the command to update the current frequency-dependent subband impairment estimate and the command to maintain the current frequency-dependent subband impairment estimate are associated with a same single bit that indicates whether to update or maintain the current frequency-dependent subband impairment estimate;
the current frequency-dependent subband impairment estimate is maintained in accordance with the single bit having a first value; and
the current frequency-dependent subband impairment estimate is updated in accordance with the single bit having a second value.

15. The UE of claim 10, wherein execution of the processor-executable code further causes the UE to estimate an initial frequency-dependent subband impairment in association with initializing a connection with the network node, wherein the initial frequency-dependent subband impairment estimate is the current frequency-dependent subband impairment estimate.

16. The UE of claim 10, wherein the first message is received in accordance with a difference between a current temperature at the network node and a previous temperature at the network node being greater than a temperature threshold, an update to one or more transmission antennas at the network node, and/or a periodic schedule.

17. The UE of claim 10, wherein execution of the processor-executable code further causes the UE to transmit, to the network node, a second message indicating a capability of the UE to cancel the frequency-dependent subband impairment.

18. A method for wireless communication by a network node, comprising:
learning a variation rate associated with a frequency-dependent subband impairment;
receiving a first message indicating a capability of a user equipment (UE) to cancel the frequency-dependent subband impairment; and
transmitting a second message indicating a command to update or maintain a current frequency-dependent subband impairment estimate in accordance with the variation rate and the UE being capable of canceling the frequency-dependent subband impairment.

19. The method of claim 18, further comprising transmitting one or more pilot symbols, wherein the current frequency-dependent subband impairment estimate is associated with the one or more pilot symbols.

20. The method of claim 18, further comprising transmitting, at each slot of a group of slots, an additional respective second message including either a command to update a respective current frequency-dependent subband impairment estimate or a command to maintain a respective current frequency-dependent subband impairment estimate.

21. The method of claim 18, wherein:
the command to update the current frequency-dependent subband impairment estimate and the command to maintain the current frequency-dependent subband impairment estimate are associated with a same single bit that indicates whether to update or maintain the current frequency-dependent subband impairment estimate;
the current frequency-dependent subband impairment estimate is maintained in accordance with the single bit having a first value; and
the current frequency-dependent subband impairment estimate is updated in accordance with the single bit having a second value.

22. The method of claim 18, wherein the variation rate is associated with one or more of a temperature threshold, an update to one or more transmission antennas at the network node, and/or a periodic schedule.

23. The method of claim 22, wherein:
the second message includes the command to update the current frequency-dependent subband impairment estimate in accordance with a difference between a current temperature at the network node and a previous temperature at the network node being greater than the temperature threshold; and
the previous temperature is associated with a time period corresponding to transmitting, prior to transmitting the second message, a third message indicating another command to update a previous frequency-dependent subband impairment.

24. The method of claim 23, wherein the second message includes the command to update the current frequency-dependent subband impairment estimate in accordance with the network node updating the one or more transmission antennas.

25. The method of claim 23, wherein the second message includes the command to update the current frequency-dependent subband impairment estimate in accordance with the periodic schedule.

26. A network node, comprising:
one or more processors; and
one or more memories coupled with the one or more processors and storing processor-executable code that, when executed by the one or more processors, is configured to cause the network node to:
learn a variation rate associated with a frequency-dependent subband impairment;
receive a first message indicating a capability of a user equipment (UE) to cancel the frequency-dependent subband impairment; and
transmit a second message indicating a command to update or maintain a current frequency-dependent subband impairment estimate in accordance with the variation rate and the UE being capable of canceling the frequency-dependent subband impairment.

27. The network node of claim 26, wherein execution of the processor-executable code further causes the network node to transmit one or more pilot symbols, wherein the current frequency-dependent subband impairment estimate is associated with the one or more pilot symbols.

28. The network node of claim 26, wherein execution of the processor-executable code further causes the network node to transmit, at each slot of a group of slots, an additional respective second message including either a command to update a respective current frequency-dependent subband impairment estimate or a command to maintain a respective current frequency-dependent subband impairment estimate.

29. The network node of claim 26, wherein:
the command to update the current frequency-dependent subband impairment estimate and the command to maintain the current frequency-dependent subband impairment estimate are associated with a same single bit that indicates whether to update or maintain the current frequency-dependent subband impairment estimate;
the current frequency-dependent subband impairment estimate is maintained in accordance with the single bit having a first value; and
the current frequency-dependent subband impairment estimate is updated in accordance with the single bit having a second value.

30. The network node of claim 26, wherein the variation rate is associated with one or more of a temperature threshold, an update to one or more transmission antennas at the network node, and/or a periodic schedule.
